(19) United States
(12) Patent Application Publication
(10) Pub. No.: US 2008/0051486 A1
(43) Pub. Date: Feb. 28, 2008

(54) HOOF REPAIR MATERIAL

(75) Inventor: Allen D. Johnston, Linwood, PA (US)

Correspondence Address: CONNOLLY BOVE LODGE & HUTZ, LLP, P O BOX 2207, WILMINGTON, DE, 19899, US

(73) Assignee: ESTECH, INC., Essington, PA (US)

(21) Appl. No.: 11/928,797

(22) Filed: Oct. 30, 2007

Related U.S. Application Data
(63) Continuation-in-part of application No. PCT/US2006/031620, filed on Aug. 14, 2006.
(60) Provisional application No. 60/707,885, filed on Aug. 12, 2005.

(51) Int. Cl. C03C 25/10

(52) U.S. Cl. 522/96

(57) ABSTRACT

A one step system for hoof repair material that cures upon exposure to light. Found is a urethane solution that contains polymerization initiators so that exposure to visible light induces the cure.

### RELATED APPLICATIONS

This application claims benefit to PCT/US2006/031620 and U.S. Provisional Application Ser. No. 60/707,885, filed Aug. 12, 2005, both of which are incorporated herein by reference in their entireties for all useful purposes.

### BACKGROUND OF THE INVENTION

The three U.S. patents that mention hoof material are U.S. Pat. Nos. 6,761,223; 6,505,686; and 6,497,292. All three deal with a two part system (A and B) for creating hoof protecting shoes that take the place of metal horse shoes. Part A contains a diisocyanate and Part B contains an alcohol. When mixed immediately before application of the dough on a hoof, these two chemicals react to create a urethane-based polymer.

### SUMMARY OF THE INVENTION

The present invention relates to a one-step system for hoof repair material that cures upon exposure to light. This one-step system provides for a liquid urethane solution that contains polymerization initiators so that exposure to visible light induces the cure.

The invention also relates to a thickened urethane liquid solution that is light curable and has a viscosity about 500 to about 100,000 cps. The thickened urethane liquid solution also must be surface-active on the hoof.

### DETAILED DESCRIPTION OF THE INVENTION

The following formulation is preferable for applying to a hoof of an animal, especially a horse or cow:

a liquid urethane, such as, but not limited to a urethane dimethacrylate (UDMA) or a urethane formed by reacting diisocyanate, preferably 2,2,4-trimethyl hexane diisocyanate or 3,3,5 hexane diisocyanate, with an alcohol or polyol. The liquid urethane is present in an amount of from 10 to about 100 weight %,

and a visible light-absorbing initiator (photoinitiator) which absorbs light in the visible light region from about 350-600 nm. Any number of commercially sold photoinitiators are employable, including photo-polymerization initiators which have hitherto been used for dental compositions, such as α-diketone compounds, ketal compounds, anthraquinone-based compounds, thioxanthone-based compounds, benzoin alkyl ether-based compounds, acyl phosphine oxide-based compounds, and α-aminoketone-based compounds. Specific examples include camphorquinone, benzil, diacetyl, benzyl dimethyl ketal, benzyl diethyl ketal, benzyl di(2-methoxyethyl) ketal, 4,4′-dimethylbenzyl-dimethyl ketal, anthraquinone, 1-chloroanthraquinone, 2-chloroanthraquinone, 1,2-benzanthraquinone, 1-hydroxyanthraquinone, 1-methylanthraquinone, 2-ethylanthraquinone, 1-bromoanthraquinone, thioxanthone, 2-isopropylthioxanthone, 2-nitrothioxanthone, 2-methylthioxanthone, 2,4-dimethylthioxanthone, 2,4-diisopropylthioxanthone, 2-chloro-7-trifluoromethylthioxanthone, thioxanthone-10,10-dioxide, thioxanthone-10-oxide, benzion methyl ether, benzoin ethyl ether, benzoin isopropyl ether, benzoin isobutyl ether, benzophenone, bis(4-dimethylaminophenyl)ketone, 4,4′-bisdiethylaminobenzophenone, 2,4,6-trimethylbenzoyl diphenylphosphine oxide, 2,6-dimethylbenzoyl diphenylphosphine oxide, 2,6-dimethoxybenzoyl diphenylphosphine oxide, bis(2,4,6-trimethylbenzoyl)phenylphosphine oxide, and 2-methyl-1-[4-(methylthio)phenyl]-2-morpholinopropan-1-one. The photo-polymerization initiators may be used either singly or in admixture of two or more thereof.

Of these, benzyl dimethyl ketal (which absorbs light at about 420 nm), camphorquinone (CQ) (which absorbs light at about 470 nm), or 2,4,6-trimethylbenzoyl diphenylphosphine oxide (which absorbs light at about 350-400 nm) are particularly preferred. The initiator would preferably be in an amount of from about 0.01 to about 5 weight %.

In addition, if desired, a photo-polymerization accelerator can be used in combination. For the photo-polymerization accelerator, an aromatic tertiary amine, an aliphatic tertiary amine, and the like are effective. Specific examples of the photo-polymerization accelerator that can be used include N,N-dimethyl-p-toluidine, N,N-diethyl-p-toluidine, N,N-dimethylaniline, N,N-bis(2-hydroxyethyl)-p-toluidine, N,N-dimethylaminoethyl methacrylate, triethanolamine, methyl 4-dimethylaminobenzoate, ethyl 4-dimethylaminobenzoate, isoamyl 4-dimethylaminobenzoate, triethylamine, N-ethyidiethanolamine, and triethanolamine. As a matter of course, these photo-polymerization accelerators may be used either singly or in admixture of two or more thereof.

The formulation may additionally contain a polymerizable monomer of a methacrylate or an acrylate containing at least one unsaturated double bond in a molecule thereof, such as, but not limited to, methyl (meth)acrylate (MMA), ethyl (meth)acrylate, isopropyl (meth)acrylate, n-butyl (meth)acrylate, isobutyl (meth)acrylate, tetrahydrofurfuryl (meth)acrylate, glycidyl (meth)acrylate, 2-methoxyethyl (meth)acrylate, 2-ethylhexyl (meth)acrylate, benzyl (meth)acrylate, 2,2-bis[(meth)acryloxyphenyl]propane, 2,2-bis[4-(meth)acryloxydiethoxyphenyl]propane, 2,2-bis[4-(meth)acryloxypolyethoxyphenyl]propane, ethylene glycol di(meth)acrylate, diethylene glycol di(meth)acrylate, triethylene glycoldi(meth)acrylate, butylene glycol di(meth)acrylate, neopentyl glycol di(meth)acrylate, 1,3-butanediol di(meth)acrylate, 1,4-butanediol di(meth)acrylate, 1,6-hexanediol di(meth)acrylate, trimethylolpropane tri(meth)acrylate, pentaerythritol tri(meth)acrylate, trimethylolmethane tri(meth)acrylate, pentaerythritol tetra(meth)acrylate, 2-hydroxyethyl (meth)acrylate, 2-hydroxypropyl (meth)acrylate, 2-hydroxy-1,3-di(meth)acryloxypropane, 1,2-dihydroxy-3-(meth)-acryloxypropane, and 2,2-bis[4-{2-hydroxy-3-(meth)-acryloxypropoxy}phenyl]propane, preferably in an amount of from about 3 to about 55 weight %. Acid group-free polymerizable monomers having a urethane bond in the molecule thereof may also be included, for example di-2-(meth)acryloxyethyl-2,2,4-trimethylhexamethylene dicarbamate (see U.S. Pat. No. 6,916,858, which is incorporated herein by reference in its entirety for all useful purposes), preferably in an amount of from about 3 to about 55 weight %.

The formulation may additionally contain a viscosity thickening agent. A number of suitable viscosity thickening agents are commercially available, including but not limited to inorganic thickening agents such as dibenzyl sorbitol (DBS), finely divided or colloidal silicas, fumed silicas, and silicates, which includes montmorillonite clays and hydrophobically treated montmorillonites, e.g., bentonites, hectorites and colloidal magnesium silicates, and also including, but not limited to, organic thickening agents such as hydrogenated butylene/ethylene/styrene copolymer, polyethylene, oxidized polyethylene, polyamides, acrylic acid polymers, ethylene acrylate copolymers, and other organic polymeric gelling agents. Preferably, the thickening agent used is DBS. Thickening agents are preferably present in an amount up to about 5 weight %.

The formulation may additionally contain bisphenol diglycidylmethacrylate (BisGMA). When used in this application, BisGMA thickens the viscosity of the polymer and imparts additional beneficial properties to the polymer, making the polymer hard, glassy, and tough. BisGMA is preferably present in an amount of from about 15 to about 75 weight %.

The formulation may additionally contain polar molecules to generate bonding influence on the surface. The polar molecules change the polarity of the polymer on the hoof. A number of suitable polar molecules are commercially available, such as 2-hydroxypropyl methacrylate, 2-hydroxyethyl methacrylate, methacryloxyethyl phthalate, the addition product of 2-hydroxyethyl methacrylate and succinic anhydride, the addition product of 1,3-glycerol dimethacrylate and maleic anhydride, the addition product of 2-hydroxyethyl methacrylate and pyrromelletic anhydride, the addition product of 1,3-glycerol dimethacrylate and pyrromelletic anhydride, and acetoacetoxyethyl methacrylate. Compounds that would be useful would be 1,3-glycerol dimethacrylate (GDMA) and HEMA phosphate (HEMA-P).

GDMA would preferably be present in an amount up to about 65 weight %. Most preferably, GDMA would be present in an amount up to about 51 weight %.

HEMA-P would preferably be present in an amount of from 0 to about 10 weight %.

The formulation may additionally contain amine photoreductant, for example ethyl 4-dimethylamino benzoate (4EDMAB), present in an amount of from 0 to about 4 weight %.

Viscosity modifiers can also be used according to the invention. A number of suitable viscosity modifiers are commercially available, including, but not limited to, ultra fine inorganic fillers such as aerosil silica, aluminum oxide, and titanium dioxide. If desired, a silica glass powder, a barium glass powder, and the like may be used.

All the percentages are on a dry weight basis unless otherwise stated.

### EXAMPLE 1

A formula was made with the following recipe:

| Item | Measured |
|---|---|
| UDMA | 35.94% |
| CQ | 0.66% |
| BisGMA | 57.27% |
| GDMA | 3.35% |
| Hema-P | 1.13% |
| 4EDMAB | 1.12% |
| DBS | 0.53% |

This formula produced a very thick hoof material with a viscosity greater than 100,000 cps.

### EXAMPLE 2

A formula was made with the following recipe:

| Item | Measured |
|---|---|
| UDMA | 76.18% |
| CQ | 0.55% |
| BisGMA | 21.71% |
| GDMA | 0% |
| Hema-P | 0.9% |
| 4EDMAB | 0.65% |
| DBS | 0.% |

This formula produced a thick hoof material with a viscosity between 20,000 and 100,000 cps.

### EXAMPLE 3

A formula was made with the following recipe:

| Item | Measured |
|---|---|
| UDMA | 30.0% |
| CQ | 2.0% |
| BisGMA | 30.0% |
| GDMA | 31.0% |
| Hema-P | 5.0% |
| 4EDMAB | 2.0% |
| DBS | 0.% |

This formula produced a thin hoof material with a viscosity lower than 20,000 cps.

### EXAMPLE 4

| Item | Lbs | Grams | % |
|---|---|---|---|
| Urethane Dimethacrylate | 10.6 | | 35.4 |
| Bis GMA | 9 | | 30 |
| 1,3-Glycerol Dimethacrylate | 9.6 | | 32 |
| HEMA Phosphate | 0.2996 | 136 | 1 |
| Camphorquinone | 0.1498 | 68 | 0.5 |
| Ethyl-4- | 0.2996 | 136 | 1 |
| Dimethylaminobenzoate | | | |
| Hydroquinone | 0.0181 | 8.2 | 0.06 |
| | 29.9671 | | 99.96 |

### EXAMPLE 5

| Item | Lbs | Grams | % |
|---|---|---|---|
| Urethane Dimethacrylate | 8.7 | | 34.9 |
| Bis GMA | 17.8 | | 51.3 |
| 1,3-Glycerol Dimethacrylate | 2.8 | | 11.3 |
| HEMA Phosphate | 0.25 | 113.4 | 1 |
| Camphorquinone | 0.125 | 56.7 | 0.5 |
| Ethyl-4- | 0.25 | 113.4 | 1 |
| Dimethylaminobenzoate | | | |
| Methyl Ether of Hydroquinone | 0.005 | 2.2 | 0.0196 |
| Hydroquinone | 0.008 | 3.4 | 0.03 |
| | 29.938 | | 100.0496 |

### EXAMPLE 6

Peanut Butter

Very Thick Hoof Material Recipe

| Item | Lbs. | Grams | % | Lbs. | % |
|---|---|---|---|---|---|
| Urethane Dimethacrylate | 15 | | 34.9 | 15.0 | 35.89 |
| Bis GMA | 23.9 | | 51.3 | 23.9 | 57.19 |
| DiBenzyl Sorbitol | | 133.5 | | 0.294 | 0.70 |
| 1,3-Glycerol | | 632.5 | 11.3 | 1.39 | 3.33 |
| Dimethacrylate | | | | | |
| HEMA Phosphate | | 210 | 1 | 0.46 | 1.11 |
| Camphorquinone | | 126.8 | 0.5 | 0.28 | 0.67 |
| Ethyl-4- | | 211 | 1 | 0.465 | 1.11 |
| Dimethylaminobenzoate | | | | | |
| | 38.9 | | 100 | 41.8 | |

### EXAMPLE 7

X 720 1000 Peanut Butter Hoof Repair Material

| Item | | Lbs | Grams | % |
|---|---|---|---|---|
| BisGMA | X 9500 0000 | 28.5 | | 57.20 |
| Urethane dimethacrylate | X 850 0000 | 17.9 | | 35.92 |
| 1,3-Glycerol | X 768 0000 | 1.65 | | 3.31 |
| Dimethacrylate | | | | |
| HEMA Phosphate | X 744 0000 | | 249.5 | 1.10 |
| Dibenzyl Sorbitol | | | 158.7 | 0.70 |
| Camphorquinone | X 801 0000 | | 149.7 | 0.66 |
| Ethyl 4- | | | 249.5 | 1.10 |
| dimethylaminobenzoate | | | | |

49.83 Lbs total

### EXAMPLE 8

X 720 0500 Thick Hoof Repair Material

| Item | | Lbs | Grams | % |
|---|---|---|---|---|
| Urethane dimethacrylate | X 850 0000 | 8.7 | | 34.89 |
| BisGMA | X 950 0000 | 12.8 | | 51.33 |
| 1,3-Glycerol | X 768 0000 | 2.8 | | 11.23% |
| Dimethacrylate | | | | |
| HEMA Phosphate | x 744 0000 | | 113.4 | 1.00 |
| Camphorquinone | X 801 0000 | | 56.7 | 0.50 |
| Ethyl 4- | | | 113.4 | 1.00 |
| dimethylaminobenzoate | | | | |
| Hydroquinone | | | 2.2 | 0.02 |
| Hydroquinone | | | 3.4 | 0.03 |

24.94 Lbs total

### EXAMPLE 9

X 720 0500 Thin Hoof Repair Material

| Item | | Lbs | Grams | % |
|---|---|---|---|---|
| Urethane | X 850 0000 | 10.6 | | 35.37 |
| dimethacrylate | | | | |
| BisGMA | X 950 0000 | 9 | | 30.03 |
| 1,3-Glycerol | X 768 0000 | 9.6 | | 32.04 |
| Dimethacrylate | | | | |
| HEMA Phosphate | x 744 0000 | | 136 | 1.00 |
| Camphorquinone | X 801 0000 | | 68 | 0.50 |
| Ethyl 4- | | | 136 | 1.00 |
| dimethylaminobenzoate | | | | |
| Hydroquinone | | | 8.2 | 0.06 |

29.97 Lbs total

For application to the hoof, an outline of a use protocol would be the following:

1. Select the appropriate material. A thicker material would be beneficial for horses or cows with bad hooves, while the thin material may be all that is necessary for hoofs in a lesser state of disrepair.

2. Paint the material on over the nails and/or in the cracks of the hoof in a dark area (such as the isle to a barn). The area need not be completely devoid of light, but should be dark enough to prevent the hardening of the material.

3. Walk the animal such as the cow or horse out into the sun and the material will instantly harden. (A thin greasy film will remain on the hoof, but this will wear off over time). For thick cracks or holes in the hoof, the application of more than one layer may be required to completely fill the hole.

4. Upon next shoeing (4-6 weeks) the material will be filed off and new material should then be applied.

This material prevents horses from throwing their shoes off with ease, where the material is applied after the shoes have been nailed to the hoof.

All the references described above are incorporated herein by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

1. A light-curable liquid acrylate solution which is surface active when applied to a hoof of an animal, comprising a liquid urethane and a visible light-absorbing initiator, wherein said solution has a viscosity of about 500 to about 250,000 cps.

2. The light-curable liquid acrylate solution of claim 1, wherein the liquid urethane is urethane dimethacrylate and is present in an amount of from about 10 to about 100 weight %.

3. The light-curable liquid acrylate solution of claim 1, wherein the visible light-absorbing initiator is benzyl dimethyl ketal, camphorquinone, or 2,4,6-trimethylbenzoyl diphenylphosphine oxide.

4. The light-curable liquid acrylate solution of claim 1, wherein the visible light-absorbing initiator is present in an amount from about 0.01 to about 5 weight %.

5. The light-curable liquid acrylate solution of claim 1, wherein the visible light-absorbing initiator absorbs light in the visible light region from about 350 to about 600 nm.

6. The light-curable liquid acrylate solution of claim 1, further comprising a viscosity thickening agent.

7. The light-curable liquid acrylate solution of claim 6, wherein the viscosity thickening agent is dibenzyl sorbitol (DIBS).

8. The light-curable liquid acrylate solution of claim 6, wherein the viscosity thickening agent is present in an amount up to about 5 weight %.

9. The light-curable liquid acrylate solution of claim 1, further comprising photo-polymerization accelerator or one or more viscosity modifiers.

10. The light-curable liquid acrylate solution of claim 1, further comprising glycerol dimethacrylate (GDMA) present in an amount not to exceed about 51 weight %.

11. The light-curable liquid acrylate solution of claim 1, further comprising HEMA phosphate (Hema-P) present in an amount not to exceed about 10 weight %.

12. The light-curable liquid acrylate solution of claim 1, further comprising amine photoreductant present in an amount not to exceed about 4 weight %.

13. The light-curable liquid acrylate solution of claim 1, further comprising bisphenol diglycidylmethacrylate (BisGMA) present in an amount from about 15 to about 75 weight %.

14. The light-curable liquid acrylate solution of claim 13, wherein the thickening agent is dibenzyl sorbitol (DBS).

15. The light-curable liquid acrylate solution of claim 1, further comprising polymerizable monomer of a methacrylate or an acrylate containing at least one unsaturated double bond in a molecule thereof in an amount of from about 3 to about 55 weight %.

16. The solution of claim 4, further comprising at least one further component selected from the group consisting of:
(a) viscosity thickening agent;
(b) photo-polymerization accelerator;
(c) viscosity modifier;
(d) amine photoreductant; and
(e) inorganic or organic thickening agent.

17. The solution of claim 2, further comprising at least one further component selected from the group consisting of:
(a) viscosity thickening agent present in amount up to about 5 weight %; and
(b) polymerizable monomer of a methacrylate or an acrylate containing at least one unsaturated double bond in a molecule thereof in an amount of from about 3 to about 55 weight %.

18. The solution of claim 3, further comprising at least one further component selected from the group consisting of:
(a) bisphenol diglycidylmethactylate (BisGMA);
(b) glycerol dimethacrylate (GDMA) present in an amount not to exceed about 65 weight %;
(c) HEMA phosphate (Hema-P) present in an amount not to exceed about 10 weight %; and
(d) dibenzyl sorbitol (DBS).

19. A method of building an animal shoe of an intended shape in situ comprising applying the liquid solution of claim 1 to a shoe area surface of an animal in a dark area and exposing the shoe area surface to light.

20. The method of claim 19, wherein said animal is a horse or cow.
